(19) United States
(12) Patent Application Publication
(10) Pub. No.: US 2022/0343322 A1
(43) Pub. Date: Oct. 27, 2022

(54) POINT OF SALE SERVER, POINT OF SALE SYSTEM, AND METHOD PERFORMED BY POINT OF SALE SERVER

(71) Applicant: TOSHIBA TEC KABUSHIKI KAISHA, Tokyo (JP)

(72) Inventor: Yoshihiro KARITA, Fukuoka Fukuoka (JP)

(21) Appl. No.: 17/670,533

(22) Filed: Feb. 14, 2022

(30) Foreign Application Priority Data
Apr. 23, 2021 (JP) 2021-073258

(51) Int. Cl. G06Q 20/38; G06Q 20/20; G06Q 20/40; G06Q 30/02

(52) U.S. Cl. CPC G06Q 20/387; G06Q 20/206; G06Q 20/202; G06Q 20/401; G06Q 30/0235; G06Q 30/0236; G06Q 30/0238

(57) ABSTRACT

A point of sale (POS) server for managing electronic coupons includes a memory that stores data of one or more electronic coupons selected by a customer in association with identification information thereof, a network interface configured to communicate with a POS terminal installed in a store, and a processor. The processor is configured to, upon receipt of the identification information of the customer and transaction data regarding a sales transaction started by the customer from the POS terminal, determine which of the selected coupons are applicable to the sales transaction, and control the network interface to transmit coupon information indicating the applicable coupons to the POS terminal.

### CROSS-REFERENCE TO RELATED APPLICATION

This application is based upon and claims the benefit of priority from Japanese Patent Application No. 2021-073258, filed Apr. 23, 2021, the entire contents of which are incorporated herein by reference.

### FIELD

Embodiments described herein relate generally to a point of sale (POS) server, a POS system, and a method performed by the POS server.

### BACKGROUND

An electronic coupon system that is widely used displays a coupon on the screen of an information terminal such as a smartphone used by a customer. The customer then present the displayed coupon to a clerk during checkout at a store to obtain a benefit such as price discount.

However, in such an electronic coupon system, during checkout, the customer needs to operate his or her information terminal to display the desired coupon on the screen to present the coupon to a clerk, which is troublesome.

### BRIEF DESCRIPTION OF THE DRAWINGS

FIG. 1 is a schematic diagram illustrating a checkout process system.

FIG. 2 depicts a data structure of a coupon record stored in a coupon database.

FIG. 3 depicts a data structure of a member record stored in a member database.

FIG. 4 is a hardware block diagram of a coupon management server.

FIG. 5 depicts a structure of distributed coupon data stored in a distributed coupon folder.

FIG. 6 depicts a structure of selected coupon data stored in a selected coupon folder.

FIG. 7 is a hardware block diagram of a POS terminal.

FIG. 8 is a flowchart of main information processing executed by a coupon management server.

FIG. 9 is a flowchart of a distributed coupon search process.

FIG. 10 is a flowchart of a main procedure executed by a POS terminal.

FIG. 11 is a flowchart of main information processing executed by a coupon management server.

FIG. 12 depicts an example of a receipt issued from a POS terminal.

### DETAILED DESCRIPTION

In general, according to one embodiment, a point of sale (POS) server for managing electronic coupons includes a memory that stores data of one or more electronic coupons selected by a customer in association with identification information thereof, a network interface configured to communicate with a POS terminal installed in a store, and a processor. The processor is configured to, upon receipt of the identification information of the customer and transaction data regarding a sales transaction started by the customer from the POS terminal, determine which of the selected coupons are applicable to the sales transaction, and control the network interface to transmit coupon information indicating the applicable coupons to the POS terminal.

Hereinafter, embodiments of a checkout process system and a coupon management apparatus in such a system will be described using the drawings.

[Configuration of Checkout Process System]

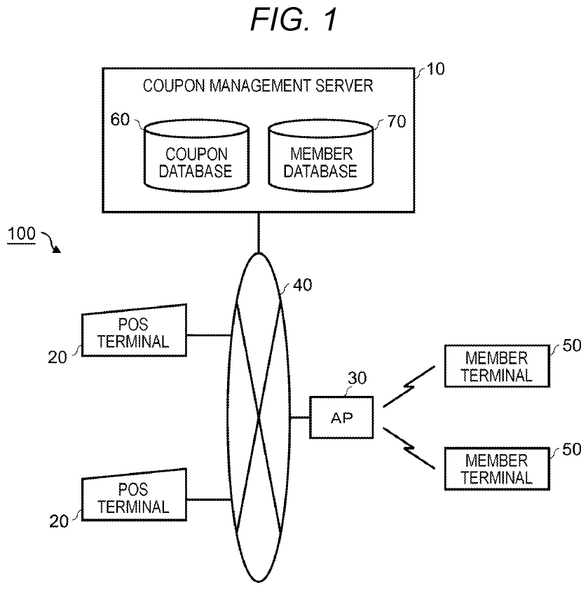

FIG. 1 is a schematic diagram illustrating a checkout process system 100. The checkout process system 100 includes a coupon management server 10, a plurality of POS terminals 20, an access point 30, and a communication network 40. The checkout process system 100 and the coupon management server 10 may be referred to as the POS system and the POS server, respectively.

The communication network 40 is typically a wide area communication network such as the Internet. The communication network 40 may be a dedicated communication network, a mobile phone communication network, or the like. A plurality of different communication networks may be used. The communication network 40 may be a wireless network or a wired network. Both of the wireless and wired networks may be used.

The coupon management server 10 is connected to the communication network 40 to provide a service as, for example, cloud computing. The coupon management server 10 provides a service for managing an electronic coupon. The electronic coupon is a coupon that a consumer can get through the communication network 40. The coupon includes information regarding a sales promotion for a consumer to obtain a benefit such as price discount when purchasing a commodity in a retail shop (hereinafter referred to as sales promotion information). The details of the coupon management server 10 will be described below.

Each of the plurality of point of sale (POS) terminals 20 is provided in a store where an electronic coupon managed by the coupon management server 10 can be used, and is connected to the communication network 40. Any number of POS terminals 20 may be provided in one store. The POS terminal 20 is a computer apparatus that processes: a registration service of registering sales data of a commodity to be purchased by a customer; and a settlement service of settling transaction with the customer. The POS terminal 20 may be a full-service type apparatus operated by a clerk to execute the registration service and the settlement service, or may be a self-service type apparatus where the registration service and the settlement service are executed by a customer. Alternatively, the POS terminal may be a semi-self-service-type apparatus where the registration service is executed by a clerk and the settlement service is executed by a customer. The details of the POS terminal 20 will be described below.

The access point 30 is connected to the communication network 40. The access point 30 is a communication device that is provided in a store so that data communication via a wireless LAN is executed between the coupon management server 10 and a member terminal 50.

The member terminal 50 is a communication apparatus that is used by a consumer who is registered as a member in order to use an electronic coupon managed by the coupon management server 10. For example, a communication apparatus such as a smartphone, a cellular phone, a tablet terminal, or a personal computer may be the member terminal 50. In the member terminal 50, an application program for using an electronic coupon is installed. Hereinafter, the application program will be referred to as “coupon application.” A consumer can receive an electronic coupon by using the coupon application.

The coupon management server 10 manages a coupon database 60 and a member database 70. Each of the coupon database 60 and the member database 70 may be stored in an internal storage device of the coupon management server 10, or may be stored in a storage apparatus externally attached to the coupon management server 10. Alternatively, each of the coupon database 60 and the member database 70 may be stored in a database server connected to the coupon management server 10 via a communication cable.

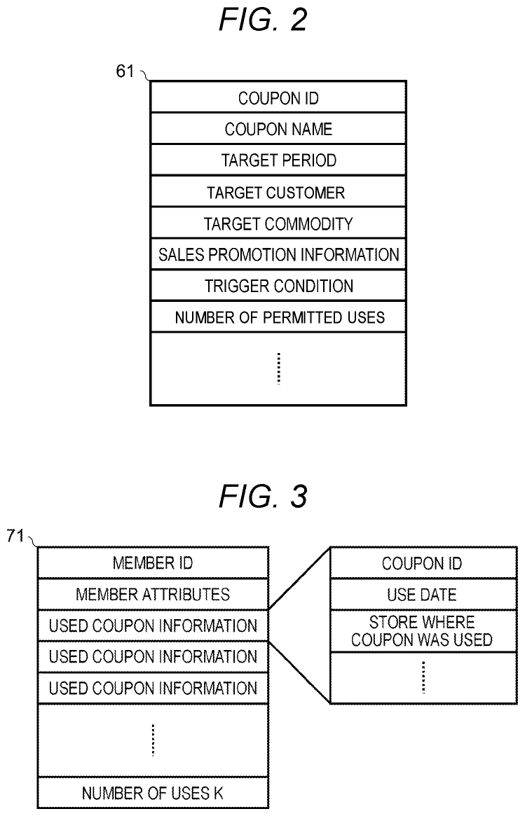

The coupon database 60 is the aggregate of coupon records 61 (refer to FIG. 2). As illustrated in FIG. 2, the coupon record 61 stores data items such as a coupon ID, a coupon name, a target period, a target customer, a target commodity, sales promotion information, a trigger condition, a number of permitted uses, and the like.

The coupon ID is a unique code issued for identifying each of the coupon records 61.

The coupon name is a specific name of the electronic coupon identified by the coupon ID.

The target period is a period in which the electronic coupon can be used. The target period may be data including a combination of a period start date and a period end date, or may be data including a combination of a period start date and the number of dates in the period.

The target customer indicates attributes of customers who can use the electronic coupon. The attributes include an age, a gender, an address, a contribution rank, and the like. For an electronic coupon that can be used irrespective of the attributes, the target customer is blank.

The target commodity indicates identification information of a commodity to which the electronic coupon applies. When a single commodity is a target, a commodity code of the commodity is set as the identification information. When a commodity belonging to a specific classification such as beverage, vegetable, meat, or sweets is a target, a classification code of the classification is set as the identification information. When a commodity provided by a specific provider is a target, a provider code of the provider (e.g., a producer code, a manufacturer code, etc.) is set as the identification information. The identification information of the target commodity is not limited to the commodity code, the classification code, or the provider code.

The sales promotion information is information regarding a benefit obtained when a customer uses the electronic coupon. For example, when the benefit is discount, the amount of discount or the discount rate is set as the sales promotion information. The sales promotion information is not limited to the discount amount or the discount rate, but may concern other promotional activities such as, for example, sales total related rewards, product giveaways, paired product promotions, two-for-one offers and the like.

The trigger condition is information regarding a condition of transaction where the electronic coupon can be used. For example, for an electronic coupon that can be used in transaction including a commodity having a relationship with the target commodity in purchased commodities, the identification information of the commodity having the relationship is set as the trigger condition. For example, for an electronic coupon that can be used in transaction where the total amount of purchased commodities is a predetermined amount or more, the total amount is set as the trigger condition. The trigger condition is not limited to the commodity identification information or the total amount of the transaction.

The number of permitted uses indicates how many times a customer as a member can use the electronic coupon. For example, for an electronic coupon that can be used up to three times, “3” is set as the number of permitted uses. For example, for an electronic coupon that can be used only once, “1” is set as the number of permitted uses. The number of permitted uses is not limited to “1” or “3”.

The member database 70 is the aggregate of member records 71 (FIG. 3). As illustrated in FIG. 3, the member record 71 stores data items such as a member ID, member attributes, used coupon information, a number of uses K, and the like.

The member ID is a unique code that is set for identify each of members who are registered customers. For example, the member ID is displayed by the display device of the member terminal 50 carried by the member in the form of a barcode or a two-dimensional data code. For example, the member ID may be recorded in a membership card issued for the member.

The member attributes are information indicating the date of birth of the member, the gender, the zip code of his or her address, his or her contribution rank (e.g., past purchase totals or membership level), or the like. The member attributes do not need to include all the above-described information. For example, when the contribution rank is not used as a condition for issuing a coupon, the contribution rank can be removed from the member attributes.

The used coupon information is information regarding an electronic coupon used by the member. The used coupon information indicates the coupon ID, the date when the coupon was used, the store where the coupon was used, or the like. Whenever a member uses an electronic coupon, the used coupon information regarding the electronic coupon is additionally registered in the member record 71.

The number of uses K is the total number of electronic coupons that have been used by the member within a predetermined period. The period may be a monthly basis such as one month or two months, or may be a yearly basis such as one year or two years. The period may be a weekly basis such as one week or two weeks.

[Configuration of Coupon Management Server]

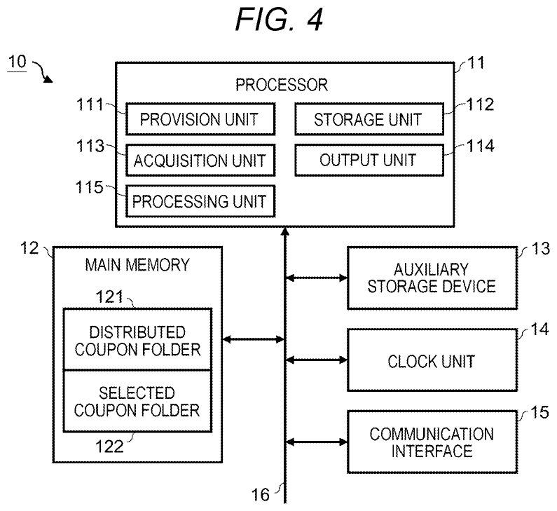

FIG. 4 is a hardware block diagram of the coupon management server 10. The coupon management server 10 includes a processor 11, a main memory 12, an auxiliary storage device 13, a clock unit 14, and a communication interface 15. In the coupon management server 10, the processor 11, the main memory 12, the auxiliary storage device 13, the clock unit 14, and the communication interface 15 are connected via a system bus 16. The system bus 16 includes an address bus or a data bus.

The processor 11 controls each of the components of the coupon management server 10 to perform various functions thereof according to an operating system and/or an application program(s). The processor 11 is, for example, a central processing unit (CPU).

The main memory 12 includes a nonvolatile memory area and a volatile memory area. The nonvolatile memory area of the main memory 12 stores the operating system and/or the application programs. The volatile memory area of the main memory 12 stores data required for the processor 11 to execute processing for controlling the components of the coupon management server 10. The volatile memory area may be used as a work area where data is rewritten by the processor 11. The nonvolatile memory area is, for example, a read only memory (ROM). The volatile memory area is, for example, a random access memory (RAM).

The auxiliary storage device 13 is, for example, a storage device, such as an electric erasable programmable read-only memory (EEPROM), a hard disk drive (HDD), or a solid state drive (SSD), or any combination thereof. The auxiliary storage device 13 stores data used for the processor 11 to execute various processes and the data generated by the processor 11 during the execution of the processes. The auxiliary storage device 13 may also store the application programs.

The main memory 12 and the auxiliary storage device 13 are embedded in the coupon management server 10. The auxiliary storage device 13 may be a storage device externally attached to the coupon management server 10.

The application programs stored in the main memory 12 or the auxiliary storage device 13 include a control program described below. A method of installing the control program in the main memory 12 or the auxiliary storage device 13 is not particularly limited. The control program can be installed in the main memory 12 or the auxiliary storage device 13 from a removable recording medium or via a network. Any recording medium may be used to install the control program as long as the program can be stored and can be read by the device, for example, a CD-ROM or a memory card.

The clock unit 14 functions as a time information source of the coupon management server 10. The processor acquires the current date and time based on time information kept by the clock unit 14.

The communication interface 15 is a network interface circuit connected to the communication network 40. The coupon management server 10 executes data communication with the POS terminal 20 or the member terminal 50 via the communication interface 15.

In the coupon management server 10 having the above-described configuration, the processor 11 performs the functions of a provision unit 111, a storage unit 112, an acquisition unit 113, an output unit 114, and a processing unit 115. The functions of the units 111 to 115 are performed by the processor 11 according to the above-described control program.

The provision unit 111 provides a function of providing, to the member terminal 50, a list of electronic coupons that are usable by a member using the member terminal 50 in response to an inquiry from the member terminal 50. In the list, the coupon name, the target period, the target commodity, the sales promotion information, and the like of each coupon record 61 are listed. The list is not limited to the above-described configuration.

The storage unit 112 provides a function of correlating information regarding an electronic coupon selected by the member from a plurality of electronic coupons with the identification information of the member, that is, the member ID, and storing the information regarding the electronic coupon and the identification information of the member. The information regarding the electronic coupon includes at least the coupon ID.

The acquisition unit 113 provides a function of acquiring the identification information of the member and the data regarding a transaction performed for the member from the POS terminal 20. The data regarding the transaction includes data regarding the commodities purchased by the member, or the total amount, the total quantity, or the like of the transaction.

The output unit 114 provides a function of controlling the communication interface 15 to output, when the data regarding the transaction acquired by the acquisition unit 113 satisfies the trigger condition of the electronic coupon that is stored in association with the identification information acquired together with the data, the sales promotion information of the electronic coupon to the POS terminal 20.

The processing unit 115 provides a function of processing, when the sales promotion information of the electronic coupon is output from the output unit 114, the electronic coupon as an electronic coupon used by the member specified by the identification information.

In order to execute each of the units 111 to 115, the coupon management server 10 uses a part of a storage area of the main memory 12 as an area for a distributed coupon folder 121 and an area for a selected coupon folder 122.

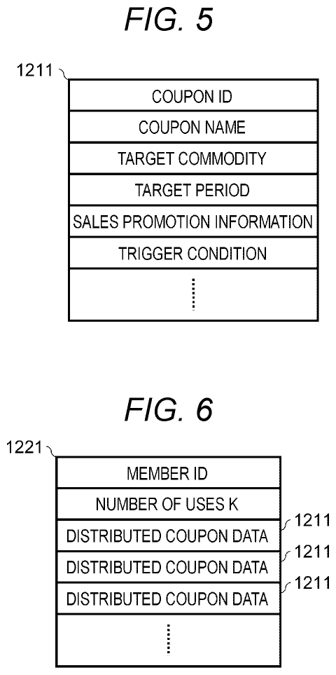

The distributed coupon folder 121 is an area for storing distributed coupon data 1211 (refer to FIG. 5). As illustrated in FIG. 5, the distributed coupon data 1211 includes the coupon ID, the coupon name, the target commodity, the target period, the sales promotion information, the trigger condition, and the like of the coupon record 61. The distributed coupon data may include items other than the above-described items.

The selected coupon folder 122 is an area for storing selected coupon data 1221 (refer to FIG. 6). As illustrated in FIG. 6, the selected coupon data 1221 includes the member ID and the number of uses K of the member record 71 and one or more pieces of the distributed coupon data 1211.

[Configuration of POS Terminal]

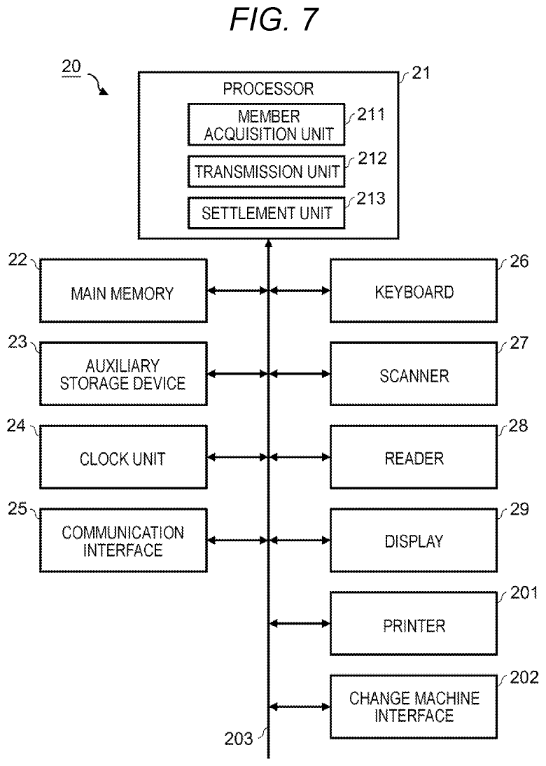

FIG. 7 is a hardware block diagram of the POS terminal 20. The POS terminal 20 includes a processor 21, a main memory 22, an auxiliary storage device 23, a clock unit 24, a communication interface 25, a keyboard 26, a scanner 27, a reader 28, a display 29, a printer 201, and a change machine interface 202. In the POS terminal 20, the processor 21, the main memory 22, the auxiliary storage device 23, the clock unit 24, the communication interface 25, the keyboard 26, the scanner 27, the reader 28, the display 29, the printer 201, and the change machine interface 202 are connected to each other via a system bus 203. The system bus 203 includes an address bus or a data bus.

The processor 21 controls each of the components of the POS terminal 20 to perform various functions thereof according to an operating system and/or an application program(s). The processor 21 is, for example, a CPU.

The main memory 22 includes a nonvolatile memory area and a volatile memory area. The nonvolatile memory area of the main memory 22 stores the operating system and/or the application programs. The volatile memory area of the main memory 22 stores data required for the processor 21 to execute processing for controlling the components of the POS terminal 20. The volatile memory area may be used as a work area where data is rewritten by the processor 21. The nonvolatile memory area is, for example, a ROM. The volatile memory area is, for example, a RAM.

The auxiliary storage device 23 is a storage device, such as an EEPROM, a HDD, or an SSD, or any combination thereof. The auxiliary storage device 23 stores data used for the processor 21 to execute various processes and the data generated by the processor 21 during the execution of the processes. The auxiliary storage device 23 may also store the application programs.

The application programs stored in the main memory 22 or the auxiliary storage device 23 include a checkout program described below. A method of installing the checkout program in the main memory 22 or the auxiliary storage device 23 is not particularly limited. The checkout program can be installed in the main memory 22 or the auxiliary storage device 23 from a removable recording medium or via a network. Any recording medium may be used to install the checkout program as long as the program can be stored and can be read by the device, for example, a CD-ROM or a memory card.

The clock unit 24 functions as a time information source of the POS terminal 20. The processor 21 acquires the current date and time based on time information kept by the clock unit 24.

The communication interface 25 is a network interface circuit connected to the communication network 40. The POS terminal 20 executes data communication with the coupon management server 10 or the like via the communication interface 25.

The keyboard 26 is an input device for inputting data required to execute the registration service, the settlement service, or the like through selection and/or pressing of keys. In the keyboard 26, various keys such as a numeric keypad, a subtotal key, or a cash total key are provided.

The scanner 27 is an input device for optically reading a barcode or a two-dimensional data code.

The reader 28 is an input device for reading data recorded in a recording medium such as a membership card, an electronic money card, a credit card, or an RFID tag.

The display 29 is an output device for displaying information to be notified to a customer during the execution of the registration service or the settlement service. For example, in the registration service, the name, the price, and the like of a commodity to be registered are displayed by the display 29. In the settlement service, the total amount, change amount, and the like of the transaction are displayed by the display 29. The POS terminal 20 is operated by a clerk when the POS terminal 20 is of a full-service type. The POS terminal 20 is operated by a customer when the POS terminal 20 is of a self-service-type. The POS terminal 20 is operated by a clerk and a customer when the POS terminal 02 is of a semi-self-service-type.

The printer 201 is an output device for printing a receipt showing the details of the transaction. The change machine interface 202 is an interface with a well-known automatic change machine. A drawer may be connected instead of the change machine interface 202. When the receipt is only issued as an electronic receipt, the printer 201 may also be omitted.

In the POS terminal 20 having the above-described configuration, the processor 21 performs functions of a member acquisition unit 211, a transmission unit 212, and a settlement unit 213. The functions of the units 211 to 213 are performed by the processor 21 according to the above-described checkout program.

The member acquisition unit 211 provides a function of acquiring the identification information of a member, that is, the member ID. When the member ID is displayed by the display device of the member terminal 50 in the form of a barcode or a two-dimensional data code, the member acquisition unit 211 acquires the member ID through the scanner 27. When the member ID is recorded in the membership card, the member acquisition unit 211 acquires the member ID through the reader 28.

The transmission unit 212 provides a function of controlling the communication interface 25 to transmit the identification information acquired by the member acquisition unit 211, that is, the member ID, and the data regarding the transaction performed for the member specified by the member ID, to the coupon management server 10.

The settlement unit 213 provides a function of settling, when sales promotion information of a coupon is received from the coupon management server 10, the transaction based on the sales promotion information.

[Operation of Checkout Process System]

Hereinafter, an operation (referred to as “first operation”) of the checkout process system 100 when a member selects an electronic coupon to be used from the electronic coupons managed by the coupon management server 10, and an operation (referred to as “second operation”) of the checkout process system 100 when a member enters a store where an electronic coupon managed by the coupon management server 10 can be used and does shopping will be described.

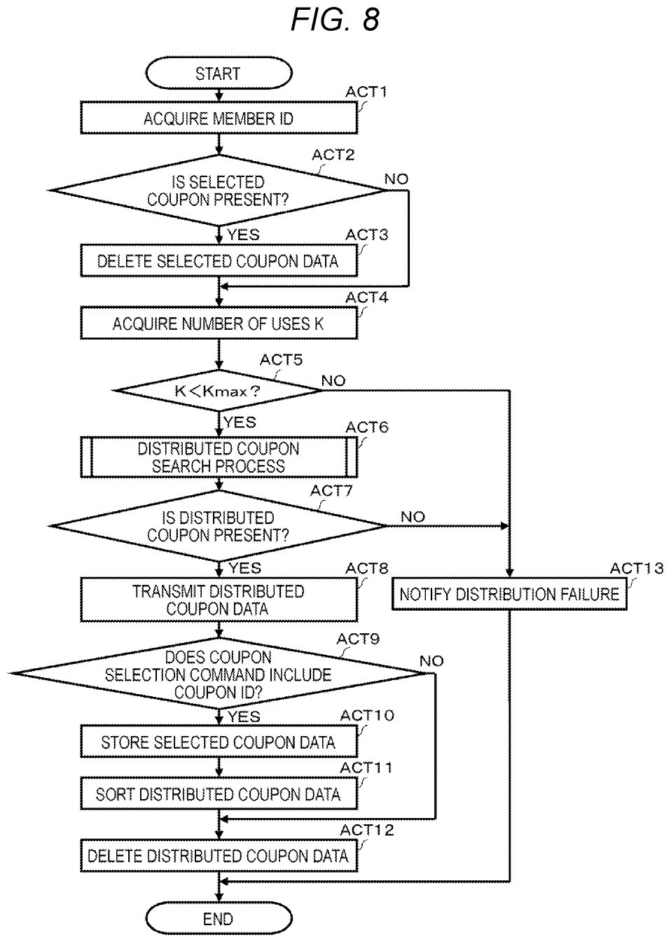

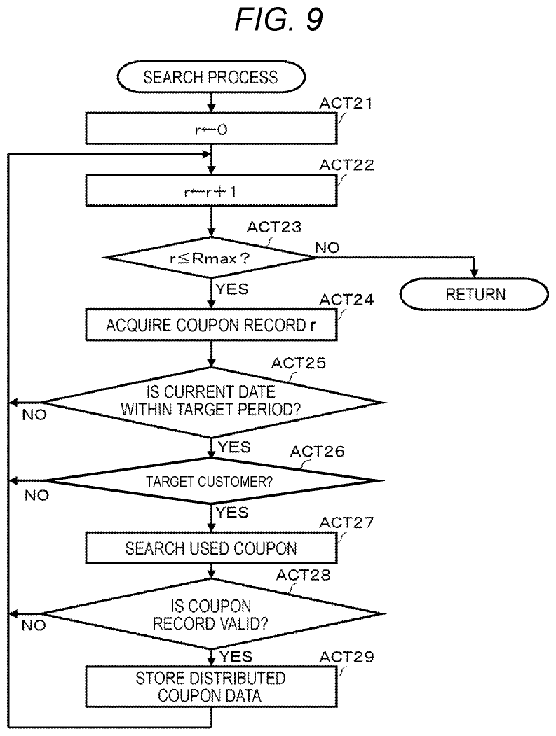

First, the first operation will be described using FIGS. 8 and 9.

FIG. 8 is a flowchart of main information processing to be executed by the processor 11 of the coupon management server 10 regarding the first operation. FIG. 9 is a flowchart of the distributed coupon search process illustrated in ACT 6 of FIG. 8. The procedures are executed according to the control program installed in the coupon management server 10. The procedures illustrated by the flowcharts of FIGS. 8 and 9 are exemplary. As long as the same effects can be obtained, the procedures can be appropriately changed.

When a member as a registered consumer wants to check the electronic coupons managed by the coupon management server 10, the member starts the coupon application installed in the member terminal 50. When the coupon application starts, a coupon inquiry button is displayed by the display device of the member terminal 50 so that the member can operate the coupon inquiry button. When the coupon inquiry button is pressed/selected, a coupon inquiry command is output from the member terminal 50 to the coupon management server 10. The coupon inquiry command includes the member ID of the member using the member terminal 50. The coupon inquiry command is wirelessly transmitted from the member terminal 50, is received by the access point 30, and is transmitted to the coupon management server 10 via the communication network 40.

Upon receipt of the coupon inquiry command, the processor 11 of the coupon management server 10 starts the procedure illustrated in the flowchart of FIG. 8. In ACT 1, the processor 11 acquires the member ID from the coupon inquiry command. In ACT 2, the processor 11 searches the selected coupon folder 122, and checks whether the selected coupon data 1221 including the member ID is stored. When the selected coupon data 1221 including the member ID is stored, the processor 11 determines YES in ACT 2 and proceeds to ACT 3. In ACT 3, the processor 11 deletes the selected coupon data 1221 including the member ID from the selected coupon folder 122. Next, the processor 11 proceeds to ACT 4. On the other hand, when the selected coupon data 1221 including the member ID is not stored in the selected coupon folder 122, the processor 11 determines NO in ACT 2, skips ACT 3, and proceeds to ACT 4.

In ACT 4, the processor 11 searches the member database 70 to acquire the number of uses K from the member record 71 including the member ID. In ACT 5, the processor 11 checks whether the number of uses K is less than the upper limit number of uses Kmax. For the number of uses K, the upper limit number of uses Kmax is set within a unit period. For example, the number of uses K is set on a monthly basis, and when an electronic coupon can be used up to 10 times within one month, the upper limit number of uses Kmax is “10.” For example, the number of uses K is set on a yearly basis, and when an electronic coupon can be used up to 100 times within one year, the upper limit number of uses Kmax is “100.” When the number of uses K is less than the upper limit number of uses Kmax, the processor 11 determines YES in ACT 5 and proceeds to ACT 6. In ACT 6, the processor 11 executes the distributed coupon search process of which the procedure is illustrated in the flowchart of FIG. 9.

That is, in ACT 21, the processor 11 clears a record counter r to “0.” Next, in ACT 22, the processor 11 counts up the record counter r by “1.” In ACT 23, the processor 11 checks whether the record counter r is less than or equal to a total number Rmax of the coupon records 61 registered in the coupon database 60.

When the record counter r is less than or equal to the total number Rmax of the coupon records 61, the processor 11 determines YES in ACT 23 and proceeds to ACT 24. In ACT 24, the processor 11 acquires the r-th coupon record 61 from the coupon database 60. Here, consecutive numbers starting from “1” are assigned to the coupon records 61 in order of registration. Accordingly, the same number as the total number Rmax is assigned to the finally registered coupon record 61. The r-th coupon record 61 refers to the coupon record 61 of which the registration order is the same as the count value of the record counter r.

When the r-th coupon record 61 is acquired, in ACT 25, the processor 11 checks whether the current date kept by the clock unit 14 is within the target period of the r-th coupon record 61. When the current date is not within the target period, the processor 11 determines NO in ACT 25 and returns to ACT 22.

When the current date is within the target period, the processor 11 determines YES in ACT 25 and proceeds to ACT 26. In ACT 26, the processor 11 checks whether the member is the target customer of the r-th coupon record 61. That is, the processor 11 acquires the member record 71 including the member ID acquired through the process of ACT 1 from the member database 70. The processor 11 checks whether the attributes of the member record 71 satisfy the attributes of the target customer of the coupon record 61. For example, assuming that conditions of the attributes of the target customer are age and gender, when the age and the gender of the member satisfy the conditions, the processor 11 determines that the member is the target customer. For example, assuming that a condition of the attributes of the target customer is a contribution rank, when the contribution rank of the member is more than or equal to the target rank, the processor 11 determines that the member is the target customer. When the member is not the target customer, the processor 11 determines NO in ACT 26 and returns to ACT 22.

When the member is the target customer, the processor 11 determines YES in ACT 26 and proceeds to ACT 27. In ACT 27, the processor 11 searches for the used coupon information of the member record 71 including the member ID of the member. In ACT 28, the processor 11 checks whether the r-th coupon record 61 is valid for the member.

As described above, the number of permitted uses is set in the coupon record 61. The processor 11 checks whether the used coupon information including the coupon ID of the r-th coupon record 61 is present in a plurality of the used coupon information and, if present, checks the number of pieces of the corresponding used coupon information. When the corresponding used coupon information is not present, the processor 11 determines that the r-th coupon record 61 is valid. Even when the corresponding used coupon information is present, if the number of pieces of the used coupon information is less than the number of permitted uses, the processor 11 determines that the r-th coupon record 61 is valid.

When the r-th coupon record 61 is valid, the processor 11 determines YES in ACT 28 and proceeds to ACT 29. In ACT 29, the processor 11 generates the distributed coupon data 1211 from the r-th coupon record 61 and stores the distributed coupon data 1211 in the distributed coupon folder 121.

On the other hand, when a plurality of the corresponding used coupon information corresponding to the number of permitted uses are present, the processor 11 determines that the r-th coupon record 61 is invalid. When the r-th coupon record 61 is invalid, the processor 11 determines NO in ACT 28 and skips the process of ACT 29. Next, the processor 11 returns to ACT 22.

The processor 11 returning to ACT 22 further counts up the record counter r by “1.” After confirming that the record counter r is less than or equal to the total number Rmax of the coupon records 61, the processor 11 executes the same processes as those of ACT 24 to ACT 29. As a result, the coupon record 61 where the current date is within the target period, the attributes of the member satisfy the conditions of the target customer, and the number of uses of the member is less than the number of permitted uses is searched. The distributed coupon data 1211 generated based on the coupon record 61 is stored in the distributed coupon folder 121.

When the record counter r exceeds the total number Rmax of the coupon record 61, the processor 11 determines NO in ACT 23 and exits from the distributed coupon search process. The processor 11 proceeds to ACT 7 of FIG. 8.

In ACT 7, the processor 11 checks whether the distributed coupon data 1211 is stored in the distributed coupon folder 121. When the distributed coupon data 1211 is stored, the processor 11 determines YES in ACT 7 and proceeds to ACT 8. In ACT 8, the processor 11 controls the distributed coupon data 1211 in the distributed coupon folder 121 to be collectively transmitted to the member terminal 50 as the transmission source of the coupon inquiry command. Due to such control, the distributed coupon data 1211 is transmitted through the communication network 40 from the communication interface 15 and is transmitted to the member terminal 50 as the transmission source of the coupon inquiry command via the access point 30.

The coupon name, the target period, the target commodity, the sales promotion information, and the like in the distributed coupon data 1211 are displayed in the form of a list by the display device of the member terminal 50 that has received the distributed coupon data 1211. Accordingly, the member operates the input device of the member terminal 50 to select an electronic coupon to be used from the list. Through such selection operation, a coupon selection command is output from the member terminal 50 to the coupon management server 10. The coupon selection command includes the member ID of the member, which is the user of the member terminal 50, and the coupon ID of the electronic coupon selected by the member. When the coupon to be used is not present in the list and the electronic coupon is not selected, a coupon selection command not including any coupon ID is output. The coupon selection command is wirelessly transmitted from the member terminal 50, is received by the access point 30, and is transmitted to the coupon management server 10 via the communication network 40.

The processor 11 of the coupon management server 10 that controls the transmission of the distributed coupon data 1211 waits for the coupon selection command. When the coupon selection command output from the member terminal 50 is received, in ACT 9, the processor 11 checks whether the coupon selection command includes the coupon ID. When the coupon selection command includes the coupon ID, the processor 11 determines YES in ACT 9 and proceeds to ACT 10.

In ACT 10, the processor 11 generates selected coupon data 1221 and stores the selected coupon data 1221 in the selected coupon folder 122. The member ID of the selected coupon data 1221 is the member ID acquired through the process of ACT 1. The number of uses K is the number of uses K acquired through the process of ACT 4. The distributed coupon data 1211 is the distributed coupon data 1211 including the coupon ID in the coupon selection command and is selected from the distributed coupon folder 121.

In ACT 11, the processor 11 sorts the distributed coupon data 1211 in the selected coupon data 1221. For example, when the sales promotion information of the distributed coupon data 1211 is a discount amount, the processor 11 sorts the distributed coupon data 1211 in order from the largest discount amount. For example, when the sales promotion information of the distributed coupon data 1211 is a discount rate, the processor 11 sorts the distributed coupon data 1211 in order from the highest discount rate. An electronic coupon having a larger discount amount or a higher discount rate is a coupon that brings a higher benefit to the member. That is, the processor 11 sorts the distributed coupon data 1211 in order from the highest benefit. The benefit is not necessarily determined based on the discount amount or the discount rate. For example, the history of commodities purchased by a member can be tracked and the distributed coupon data 1211 may be sorted such that an electronic coupon for a commodity that is more frequently purchased by the member is positioned on a higher level as a coupon bringing a higher benefit.

When the processes of ACT 10 and ACT 11 end or the coupon selection command does not include the coupon ID and when the processor determines NO in ACT 9, the processor 11 proceeds to ACT 12. In ACT 12, the processor 11 deletes the distributed coupon data 1211 stored in the distributed coupon folder 121. Hereinabove, the processor 11 ends the information processing when the number of uses K is less than the upper limit number of uses Kmax in ACT 3.

On the other hand, when the number of uses K is more than or equal to the upper limit number of uses Kmax, the processor 11 determines NO in ACT 5 and proceeds to ACT 13. When the distributed coupon data 1211 is not stored in the distributed coupon folder 121 as a result of the distributed coupon search process, the processor 11 determines NO in ACT 7 and proceeds to ACT 13. In ACT 13, the processor 11 controls a response command of distribution failure to be notified to the member terminal 50 as the transmission source of the coupon inquiry command. Due to such control, the response command of distribution failure is transmitted through the communication network 40 from the communication interface 15 and is transmitted to the member terminal 50 as the transmission source of the coupon inquiry command via the access point 30. A message notifying that a usable coupon is not present is displayed by the display device of the member terminal 50 that receives the response command of distribution failure. Hereinabove, the processor 11 ends the information processing when the number of uses K is more than or equal to the upper limit number of uses Kmax in ACT 3.

Here, in the coupon management server 10, the processor 11 performs the function of the provision unit 111 by executing the processes of ACT 1 to ACT 8 in FIG. 8. In the coupon management server 10, the processor 11 performs the function of the storage unit 112 by executing the process of ACT 10.

By operating the member terminal 50, the member can select one or more electronic coupons to be used from the electronic coupons that can be used by the member among the electronic coupons managed by the coupon management server 10. By selecting the electronic coupons, the selected coupon data 1221 in which the member ID of the member and the distributed coupon data of the electronic coupons selected by the member are associated with each other are stored in the selected coupon folder 122.

The selected coupon data 1221 are stored in the selected coupon folder 122 such that coupon data having higher benefit for the member is positioned on a higher level.

When the coupon inquiry command is transmitted from the member terminal 50, if any selected coupon data 1221 including the member ID of the command is stored in the selected coupon folder 122, the selected coupon data 1221 is deleted. Accordingly, two or more pieces of the selected coupon data 1221 including the member ID of the same member are not stored in the selected coupon folder 122.

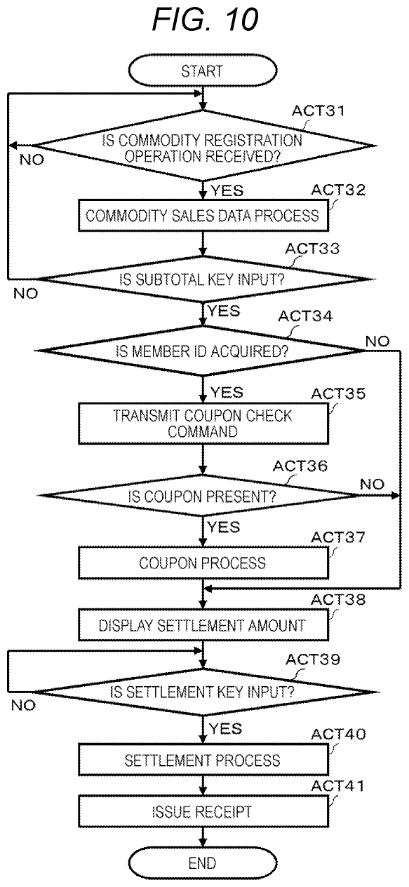

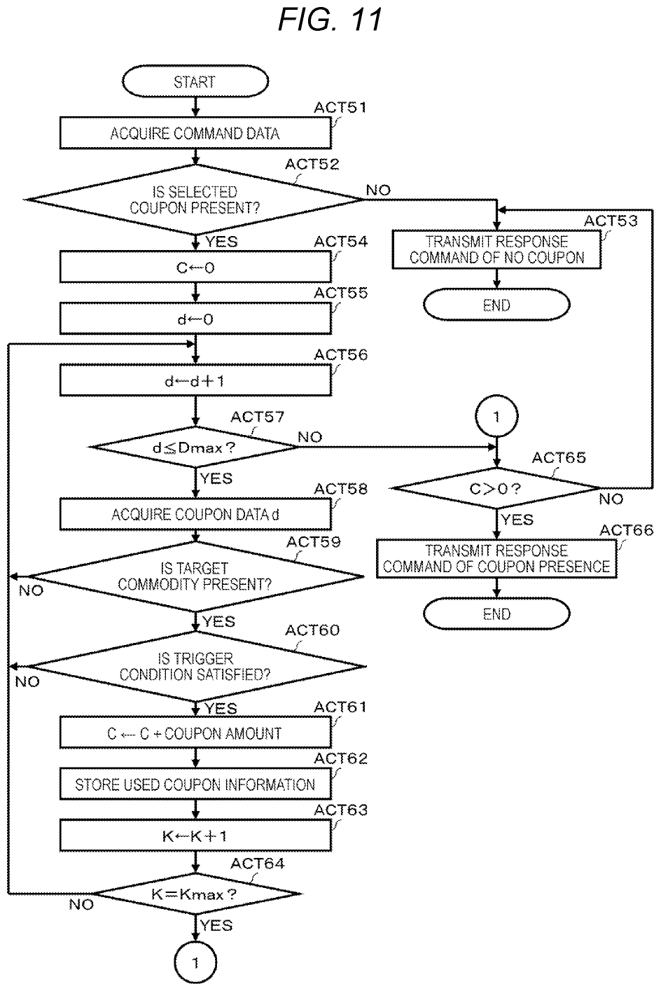

Next, the second operation will be described using FIGS. 10 and 11.

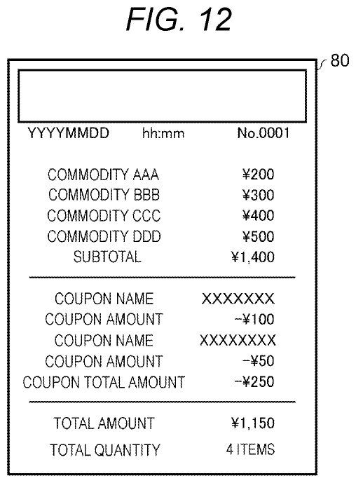

FIG. 10 is a flowchart of a main procedure to be executed by the processor 21 of the POS terminal 20 regarding the second operation. The procedure is executed according to the checkout program. FIG. 11 is a flowchart of main information processing to be executed by the processor 11 of the coupon management server 10 regarding the second operation. The procedure is executed according to the control program installed in the coupon management server 10. FIG. 12 illustrates an example of a receipt 80 issued from the POS terminal 20. The procedures illustrated by the flowcharts of FIGS. 10 and 11 are exemplary. As long as the same effects can be obtained, the procedures can be appropriately changed.

The processor 21 waits for commodity registration in ACT 31 of FIG. 10. When the registration operation of the purchased commodities is received through the keyboard 26 or the scanner 27, the processor 21 determines YES in ACT 31 and proceeds to ACT 32. In ACT 32, the processor 21 executes a commodity sales data process. The commodity sales data process is a process of registering commodity sales data including commodity codes, commodity names, prices, sales quantities, and sales amounts of the purchased commodities in a transaction memory. The transaction memory is a part of the storage area secured in the main memory 22. The process includes a process of displaying the commodity names, the sales amounts, and the like of the commodity sales data on the display 29.

When the commodity sales data process ends, in ACT 33, the processor 21 checks whether the subtotal key of the keyboard 26 is selected. When the subtotal key is not selected, the processor 21 returns to ACT 31. When the commodity registration of the purchased commodities is executed again, the processor 21 executes the above-described commodity sales data process. As such, the processor 21 repeatedly executes the commodity sales data process whenever the registration operation of the purchased commodities is executed.

When the registration operation of the purchased commodities ends, the subtotal key is selected (pressed). When the subtotal key is selected, the processor 21 determines YES in ACT 33 and proceeds to ACT 34. In ACT 34, the processor 21 checks whether the member ID is acquired. For example, the member ID can be acquired by reading the code of the member ID displayed by the display device of the member terminal 50 with the scanner 27. Alternatively, the member ID can be acquired by reading the member ID recorded in the membership card with the reader 28. The timing at which the member ID is acquired may be before the pressing of the subtotal key or may be after the pressing of the subtotal key.

When the member ID is not acquired, the processor 21 determines NO in ACT 34. The processor 21 skips the processes of ACT 35 to ACT 37 described below and proceeds to ACT 38. In ACT 38, the processor 21 causes the display 29 to display the settlement amount. The settlement amount is the total amount including tax of the commodity sales data registered in the transaction memory.

When the member ID is acquired, the processor 21 determines YES in ACT 34 and proceeds to ACT 35. In ACT 35, the processor 21 controls a coupon check command to be transmitted to the coupon management server 10. Due to such control, the coupon check command is transmitted from the communication interface 25 to the coupon management server via the communication network 40. The coupon check command includes: the member ID acquired from the member terminal 50 or the membership card; and store information for specifying the store where the POS terminal 20 is provided. The store information is, for example, a unique store code set for the store. The store information may include the store name. The coupon check command includes, as data regarding transaction performed for the member, the commodity sales data of the purchased commodities and the total quantity, the total amount, and the like thereof.

The coupon management server 10 that has received the coupon check command starts the procedure illustrated in the flowchart of FIG. 11. In ACT 51, the processor 11 acquires the member ID, the store information, and the data regarding the transaction of the member from the coupon check command. In ACT 52, the processor 11 checks whether the selected coupon data 1221 including the member ID acquired from the coupon check command is stored in the selected coupon folder 122.

When the corresponding selected coupon data 1221 is not stored in the selected coupon folder 122, the processor 11 determines NO in ACT 52 and proceeds to ACT 53. In ACT 53, the processor 11 controls the communication interface 15 to transmit a response command of no coupon to the POS terminal 20 as the transmission source of the coupon check command. Due to such control, the response command of no coupon is transmitted to the POS terminal 20 as the transmission source of the coupon check command via the communication interface 15.

On the other hand, when the corresponding selected coupon data 1221 is stored in the selected coupon folder 122, the processor 11 determines YES in ACT 52 and proceeds to ACT 54. In ACT 54, the processor 11 clears a coupon amount buffer C to “0.” In ACT 55, the processor 11 clears a data counter d to “0.” Next, in ACT 56, the processor 11 counts up the data counter d by “1.” In ACT 57, the processor 11 checks whether the data counter d is less than or equal to a total number Dmax of the distributed coupon data 1211 in the selected coupon data 1221.

When the data counter d is less than or equal to the total number Dmax of the distributed coupon data 1211, the processor 11 determines YES in ACT 57 and proceeds to ACT 58. In ACT 58, the processor 11 acquires the d-th distributed coupon data 1211. Here, as described in ACT 11 of FIG. 8, when the selected coupon data 1221 includes a plurality of distributed coupon data 1211, each of the distributed coupon data 1211 is sorted in descending order according to the benefit. The d-th distributed coupon data 1211 is the distributed coupon data 1211 at the rank of benefit that is the same as the count value of the record counter d. That is, the processor 11 acquires the distributed coupon data 1211 in order from the highest benefit.

In ACT 59, the processor 11 checks whether the target commodity of the distributed coupon data 1211 is purchased by the member. That is, the processor 11 checks whether the data regarding the transaction of the member acquired from the coupon check command includes the commodity sales data of the target commodity. When the data regarding the transaction does not include the commodity sales data of the target commodity, the processor 11 determines NO in ACT 59 and returns to ACT 56.

When the data regarding the transaction includes the commodity sales data of the target commodity, the processor 11 determines YES in ACT 59 and proceeds to ACT 60. In ACT 60, the processor 11 checks whether a trigger condition of the distributed coupon data 1211 is satisfied.

For example, when the identification information of a commodity having a relationship is set as the trigger condition, the processor 11 checks whether the data regarding the transaction of the member acquired from the coupon check command includes the commodity sales data of the target commodity having the relationship. When the commodity sales data of the target commodity having the relationship is not included, the trigger condition is not satisfied. When the commodity sales data of the target commodity having the relationship is included, the trigger condition is satisfied. For example, when the total amount is set as the trigger condition, the processor 11 checks whether the total amount of the data regarding the transaction for the member acquired from the coupon check command is more than or equal to the set amount. When the total amount is less than the set amount, the trigger condition is not satisfied. When the total amount is more than or equal to the set amount, the trigger condition is satisfied.

When the trigger condition is not satisfied, that is, when the electronic coupon of the coupon ID in the distributed coupon data 1211 cannot be used during the checkout of the transaction with the member, the processor 11 determines NO in ACT 60 and returns to ACT 56.

When the trigger condition is satisfied, that is, when the electronic coupon of the coupon ID in the distributed coupon data 1211 can be used during the checkout of the transaction with the member, the processor 11 determines YES in ACT 60 and proceeds to ACT 61. In ACT 61, the processor 11 adds a coupon amount to the coupon amount buffer C. When the sales promotion information of the distributed coupon data 1211 is a discount amount, the coupon amount is simply the discount amount. When the sales promotion information of the distributed coupon data 1211 is a discount rate, the coupon amount is the amount obtained by multiplying the sales amount by the discount rate.

In ACT 62, the processor 11 stores the used coupon information. That is, the processor 11 generates the used coupon information from the coupon ID of the d-th distributed coupon data 1211, the date kept by the clock unit 14, and the store information acquired from the coupon check command. The processor 11 adds the used coupon information to the member record 71 including the member ID acquired in ACT 51.

In ACT 63, the processor 11 adds the number of uses K of the member record 71 by “1.” In ACT 64, the processor 11 checks whether the number of uses K has reached the upper limit number of uses Kmax. When the number of uses K has not reached the upper limit number of uses Kmax, the processor 11 determines NO in ACT 64 and returns to ACT 56.

As such, when the target commodity of the distributed coupon data 1211 is not purchased by the member, when the target commodity is purchased but the data regarding the transaction does not satisfy the trigger condition, or when the data regarding the transaction satisfies the trigger condition and the number of uses K has not reached the upper limit number of uses Kmax, the processor 11 returns to ACT 56. The processor 11 further counts up the data counter d, and when the processor 11 confirms that the data counter d is less than or equal to the total number Dmax of the distributed coupon data 1211, the processor 11 executes the same processes as those of ACT 58 to ACT 64.

When the data counter d exceeds the total number Dmax of the distributed coupon data 1211 or when the number of uses K has reached the upper limit number of uses Kmax, the processor 11 determines NO in ACT 57 or YES in ACT 64 and proceeds to ACT 65. In ACT 65, the processor 11 checks whether the coupon amount of the coupon amount buffer C is more than 0 yen. When the coupon amount of the coupon amount buffer C is 0 yen, an electronic coupon that can be used during the checkout of the transaction with the member is not present. The processor 11 determines NO in ACT 65 and proceeds to ACT 53 described above. That is, the processor 11 controls the communication interface 15 to transmit a response command of no coupon to the POS terminal 20 as the transmission source of the coupon check command.

When the coupon amount of the coupon amount buffer C is more than 0, an electronic coupon that can be used during the checkout of the transaction with the member is present. The processor 11 determines YES in ACT 65 and proceeds to ACT 66. In ACT 66, the processor 11 controls the communication interface 15 to transmit a response command of coupon presence to the POS terminal 20 as the transmission source of the coupon check command. Due to such control, the response command of coupon presence is transmitted to the POS terminal 20 as the transmission source of the coupon check command via the communication interface 15. The response command of coupon presence includes: the coupon name and the coupon amount of the distributed coupon data 1211 satisfying the trigger condition; and the total amount of discount stored in the coupon amount buffer C.

The processor 11 that outputs the response command of no coupon or coupon presence ends the information processing when receiving the coupon check command.

Referring back to FIG. 10, in ACT 36, after the coupon check command has been transmitted, the processor 21 of the POS terminal 20 waits for the response command from the coupon management server 10. When the response command of no coupon is received, the processor 21 determines NO in ACT 36, skips the process of ACT 37 described below, and proceeds to ACT 38. In ACT 38, the processor 21 causes the display 29 to display the settlement amount.

When the response command of coupon presence is received, the processor 21 determines YES in ACT 36 and proceeds to ACT 37. In ACT 37, the processor 21 executes a coupon process. Specifically, the processor 21 calculates the settlement amount of the transaction by subtracting the total amount of discount in the response command of coupon presence from the total amount of the commodity sales data registered in the transaction memory. Next, the processor 11 proceeds to ACT 38. In ACT 38, the processor 21 causes the display 29 to display the settlement amount.

In ACT 39, the processor 21 waits for the selection of a settlement key. As the settlement key, for example, a cash total key that is a settlement key for cash payment, a credit key that is a settlement key for credit card payment, or an electronic money key that is a settlement key for electronic money payment can be used. The processor 21 waits for the selection (e.g., pressing) of any of the settlement keys.

When the settlement key is pressed, the processor 21 determines YES in ACT 39 and proceeds to ACT 40. In ACT 40, the processor 21 executes a settlement process based on the settlement amount. Examples of the settlement process include a settlement process for cash payment, a settlement process for credit card payment, and a settlement process for electronic money payment. In any of the settlement processes, in transaction where an electronic coupon is used, the settlement process for the settlement amount to which the electronic coupon is applied executed. The settlement processes are well-known processes, and detailed description will not be further made.

When the settlement process ends, in ACT 41, the processor 21 controls the issuance of a receipt and ends the procedure illustrated in the flowchart of FIG. 10.

FIG. 12 is an example of the receipt 80 issued for the transaction where multiple electronic coupons are used. As illustrated in the drawing, the receipt 80 displays the names and prices of the purchased commodities, the subtotal amount of the purchased commodities, the coupon names and discount amounts of the electronic coupons, the total discount amount of the electronic coupons, the total amount of the transaction, that is, the settlement amount, and the total quantity. The items and arrangement of the texts displayed on the receipt 80 are not limited to those illustrated in FIG. 12. The receipt 80 allows a customer to recognize that the electronic coupons have been used in the transaction of the purchased commodities.

Here, in the POS terminal 20, the processor 21 performs the function of the member acquiring unit 211 by executing the process of ACT 34 of FIG. 10. The processor 21 performs the function of the transmission unit 212 by executing the process of ACT 35. The processor 21 performs the function of the settlement unit 213 by executing the processes of ACT 37 to ACT 40.

On the other hand, in the coupon management server 10, the processor 11 performs the function of the acquisition unit 113 by executing the process of ACT 51 in FIG. 11. In the coupon management server 10, the processor 11 performs the function of the output unit 114 by executing the processes of ACT 56 to ACT 61 and ACT 63 to ACT 66. In the coupon management server 10, the processor 11 performs the function of the processing unit 115 by executing the process of ACT 62.

According to the above-described functions, the following effects can be exhibited.

That is, a member who has selected an electronic coupon to be used presents the member ID during shopping in a store. As a result, the member ID and the data regarding the transaction performed for the member are transmitted from the POS terminal 20 to the coupon management server 10. The coupon management server 10 checks whether the data regarding the transaction satisfies the trigger condition of the electronic coupon stored in association with the member ID. When the trigger condition is satisfied, the sales promotion information of the electronic coupon is output to the POS terminal 20. In the POS terminal 20, the transaction for the member is settled based on the sales promotion information. Accordingly, the member can use the desired electronic coupon without controlling the member terminal 50 to display the electronic coupon to and presenting the electronic coupon to a clerk during checkout.

In the coupon management server 10, the information regarding an electronic coupon used by each member is managed as the used coupon information for the member. Regarding an electronic coupon of which the number of uses is limited, when the number of uses reaches the limited number of times (the number of permitted uses), the electronic coupon is excluded from the electronic coupon selection list. Accordingly, the electronic coupon that has been used up to the limited number of times can be prevented in advance from being selected by the member.

If the total number of electronic coupons that can be used by a member within a given period is limited, when the number of used electronic coupons reaches the upper limit number of uses Kmax that is the limited value, no electronic coupon can be selected. Accordingly, the member who has used electronic coupons up to the upper limit number of uses Kmax can be prevented in advance from selecting any electronic coupon. Until the number of used electronic coupons reaches the upper limit, a determination of whether a coupon can be used is made with priority given to electronic coupons having higher benefit for the member. Accordingly, disadvantage can be prevented that may occur when an electronic coupon having lower benefit can be used and an electronic coupon having higher benefit cannot be used because of the upper limit number of uses Kmax reached.

The possible embodiments of the checkout process system 100 and the coupon management server 10 are not limited to the examples specifically described.

For example, the coupon management server 10 may be divided into a first server that manages the coupon database 60 and a second server that manages the member server 70 or corresponding database.

While certain embodiments have been described, these embodiments have been presented by way of example only, and are not intended to limit the scope of the disclosure. Indeed, the novel apparatus and methods described herein may be embodied in a variety of other forms; furthermore, various omissions, substitutions and changes in the form of the apparatus and methods described herein may be made without departing from the spirit of the disclosure. The accompanying claims and their equivalents are intended to cover such forms or modifications as would fall within the scope and spirit of the disclosure.

What is claimed is:

1. A point of sale (POS) server for managing electronic coupons, the POS server comprising:
a memory that stores data of one or more electronic coupons selected by a customer in association with identification information;
a network interface configured to communicate with a POS terminal of a store; and
a processor configured to:
upon receipt of the identification information of the customer and transaction data regarding a sales transaction started by the customer from the POS terminal, determine which of the selected coupons are applicable to the sales transaction, and
control the network interface to transmit coupon information indicating the applicable coupons to the POS terminal.

2. The POS server according to claim 1, wherein
the network interface is further configured to communicate with a customer terminal operated by the customer, and
the processor is further configured to control the network interface to transmit a list of electronic coupons that are available to the customer in response to an inquiry from the customer terminal.

3. The POS server according to claim 2, wherein the processor is further configured to identify one or more of the electronic coupons listed and selected via the customer terminal and then store data of said one or more of the electronic coupons in the memory in association with the identification information of the customer.

4. The POS server according to claim 2, wherein
the processor is further configured to store in the memory a number of uses of each electronic coupon by the customer, and
an electronic coupon that has been used by the customer a predetermined number of times is excluded from the list.

5. The POS server according to claim 4, wherein the processor is further configured to reset the number of uses periodically.

6. The POS server according to claim 2, wherein the processor is further configured to sort the applicable coupons in order of benefit to the customer.

7. The POS server according to claim 6, wherein the processor sorts the applicable coupons according to an amount or rate of discount by each coupon.

8. The POS server according to claim 1, wherein the data of one or more electronic coupons stored in the memory includes, for each electronic coupon, one or more attributes of target customers for which the coupon is applicable.

9. The POS server according to claim 8, wherein
the memory further stores data of attributes of the customer, and
the determination of which coupons are applicable is made based on the attributes of the customer.

10. The POS server according to claim 1, wherein the POS terminal is a self-service type POS terminal or a semi-self-service-type POS terminal.

11. A point of sale (POS) system, comprising:
a POS terminal of a store and configured to:
when starting a sales transaction, acquire identification information of a customer, and
output the identification information and transaction data regarding the sales transaction; and
a POS server including:
a memory that stores data of one or more electronic coupons selected by the customer in association with the identification information,
a network interface configured to communicate with the POS terminal, and
a processor configured to:
upon receipt of the identification information of the customer and the transaction data from the POS terminal, determine which of the coupons associated with the identification information are applicable to the sales transaction, and
control the network interface to transmit coupon information about the applicable coupons to the POS terminal, wherein
the POS terminal is further configured to execute the sales transaction based on the coupon information received from the POS server.

12. The POS system according to claim 11, wherein
the network interface is further configured to communicate with a customer terminal operated by the customer, and
the processor is further configured to control the network interface to transmit a list of electronic coupons that are available to the customer in response to an inquiry from the customer terminal.

13. The POS system according to claim 12, wherein the processor is further configured to identify one or more of the electronic coupons listed and selected via the customer terminal and then store data of said one or more of the electronic coupons in the memory in association with the identification information of the customer.

14. The POS system according to claim 12, wherein
the processor is further configured to store in the memory a number of uses of each electronic coupon by the customer, and
an electronic coupon that has been used by the customer a predetermined number of times is excluded from the list.

15. The POS system according to claim 14, wherein the processor is further configured to reset the number of uses periodically.

16. The POS system according to claim 12, wherein the processor is further configured to sort the applicable coupons in order of benefit to the customer.

17. The POS system according to claim 16, wherein the processor sorts the applicable coupons according to an amount or rate of discount by each coupon.

18. The POS system according to claim 11, wherein
the data of one or more electronic coupons stored in the memory includes, for each electronic coupon, one or more attributes of target customers for which the coupon is applicable,
the memory further stores data of attributes of the customer, and
the determination of which coupons are applicable is made based on the attributes of the customer.

19. The POS server according to claim 1, wherein the POS terminal is a self-service type POS terminal or a semi-self-service-type POS terminal.

20. A method performed by a point of sale (POS) server for managing electronic coupons, the method comprising:
storing data of one or more electronic coupons selected by a customer in association with identification information thereof;
upon receipt of the identification information of the customer and transaction data regarding a sales transaction started by the customer from a POS terminal installed in a store, determining which of the coupons associated with the identification information are applicable to the sales transaction; and
transmitting coupon information about the applicable coupons to the POS terminal.
